(19) United States
(12) Patent Application Publication
(10) Pub. No.: US 2010/0137001 A1
(43) Pub. Date: Jun. 3, 2010

(54) TERMINAL AND METHOD FOR PROVIDING TERMINAL POSITION

(75) Inventors: Youngsu CHO, Seoul (KR); Byung Doo KIM, Daejeon (KR); Seong Yun CHO, Daejeon (KR); Sung Jo YUN, Daejeon (KR); Sun-Joong KIM, Daejeon (KR); Wan Sik CHOI, Daejeon (KR); Jong-Hyun PARK, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: ELECTRONICS AND TELECOMMUNICATIONS RESEARCH INSTITUTE, Daejeon (KR)

(21) Appl. No.: 12/582,570

(22) Filed: Oct. 20, 2009

(30) Foreign Application Priority Data
Dec. 1, 2008 (KR) 10-2008-0120729
Apr. 6, 2009 (KR) 10-2009-0029617

(51) Int. Cl. H04W 24/00; H04B 1/38

(52) U.S. Cl. 455/456.1; 455/558

(57) ABSTRACT

The present invention relates to a terminal and a terminal location providing method. The terminal for selectively accessing a plurality of base stations supporting different communication systems includes a first network interface card that is turned on when the terminal is turned on, a second network interface card that is turned on or activated when receiving the terminal's location information request, a power controller for controlling power of the first and second network interface cards, and a processor for receiving the terminal's location information request and controlling the power of the first and second network interface cards through the power controller.

### CROSS-REFERENCE TO RELATED APPLICATION

This application claims priority to and the benefit of Korean Patent Application No. 10-2008-0120729 filed in the Korean Intellectual Property Office on Dec. 1, 2008, and Korean Patent Application No. 10-2009-0029617 filed in the Korean Intellectual Property Office on Apr. 6, 2009, the entire contents of which are incorporated herein by reference.

### BACKGROUND OF THE INVENTION

(a) Field of the Invention

The present invention relates to a terminal and a method for providing a terminal position.

(b) Description of the Related Art

The recent wireless communication system has been developed to provide data services as well as voice services. As the wireless communication system has evolved, a user can use multiple wireless networks in order to select various wireless communication networks according to environments such as access possibility and mobility. The various services provided by the multiple wireless communication networks can be maximized by the location-based service (LBS).

However, in order to apply the location-based service in the multiple wireless communication network, a communication service provider or a service provider is required to efficiently manage the resource among the wireless communication networks, and a terminal must have a hand-off function between the communication networks and the power management function.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide more accurate location information while efficiently managing power consumption when providing a location-based service to a terminal using multiple wireless communication networks.

An exemplary embodiment of the present invention provides a terminal for selectively accessing a plurality of base stations supporting different communication systems, including: a first network interface card that is turned on when the terminal is turned on; a second network interface card that is turned on or activated when receiving the terminal's location information request; a power controller for controlling power of the first and second network interface cards; and a processor for receiving the terminal's location information request and controlling the power of the first and second network interface cards through the power controller.

The first network interface card controls the terminal to access the first base station from among the plurality of base stations, and the second network interface card controls the terminal to access the second base station from among the plurality of base stations, wherein power consumption of the terminal when accessing the first base station is less than that when accessing the second base station.

The first network interface card controls the terminal to access the first base station from among the plurality of base stations, and the second network interface card controls the terminal to access the second base station from among the plurality of base stations, wherein a communication area of the first base station is wider than a communication area of the second base station.

The processor collects the location information through the second base station while the second network interface card is turned on or activated.

The second network interface card is turned off or it enters a standby mode when the location information is collected.

The terminal further includes a non-network-based interface card that is turned on or activated when receiving the terminal's location information request.

The processor collects the location information when the non-network-based interface card is turned on or activated.

The non-network-based interface card is turned off or enters the standby mode when the location information is collected.

Another embodiment of the present invention provides a method for providing a location of a terminal selectively accessing a plurality of base stations supporting different communication systems, including: controlling the terminal to access a first base station; receiving the terminal's location information request from a service requester; controlling the terminal to access a second base station while accessing the first base station when receiving the terminal's location information request; controlling the terminal to collect the location information from the first and second base stations; and providing the location information to the service requester.

The terminal's power consumption when accessing the first base station is greater than that when accessing the second base station.

The method further includes controlling the terminal to disconnect access to the second base station after providing the location information to the service requester.

The method further includes controlling the terminal to access a non-network-based positioning system while the terminal is connected to the first base station after receiving the terminal's location information request.

The method further includes controlling the terminal to collect the location information from the non-network-based positioning system.

The method further includes controlling the terminal to disconnect the access to the non-network-based positioning system after the providing of the location information to the service requester.

The terminal includes a first network interface card for controlling the terminal to access the first base station, and the controlling of the terminal to access the first base station includes turning on the first network interface card.

The terminal includes a second network interface card for controlling the terminal to access the second base station, and the controlling of the terminal to access the second base station includes turning on or activating the second network interface card.

The terminal includes a non-network-based interface card for controlling the terminal to access the non-network-based positioning system, and the controlling of the terminal to access the non-network-based positioning system includes turning on or activating the non-network-based interface card.

According to an embodiment of the present invention, power consumption is efficiently managed and accurate location information is provided when a location-based service is provided to a terminal using multiple wireless communication networks.

### BRIEF DESCRIPTION OF THE DRAWINGS

FIG. 1 shows a wireless communication system according to an exemplary embodiment of the present invention.

FIG. 2 shows a block diagram of a terminal according to an exemplary embodiment of the present invention.

FIG. 3 shows a flowchart of a method for a terminal to provide location information according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

In the specification, a mobile station (MS) may indicate a terminal, a mobile terminal (MT), a subscriber station (SS), a portable subscriber station (PSS), user equipment (UE), and an access terminal (AT), and it may include entire or partial functions of the terminal, the mobile terminal, the subscriber station, the portable subscriber station, the user equipment, and the access terminal.

In the specification, a base station (BS) may indicate an access point (AP), a radio access station (RAS), a nodeB (Node-B), an evolved Node-B (eNB), a base transceiver station (BTS), and a mobile multihop relay (MMR)-BS, and it may include entire or partial functions of the access point, the radio access station, the nodeB, the evolved Node-B, the base transceiver station, and the mobile multihop relay-BS.

A terminal according to an exemplary embodiment of the present invention and the terminal's location providing method will now be described with reference to accompanying drawings.

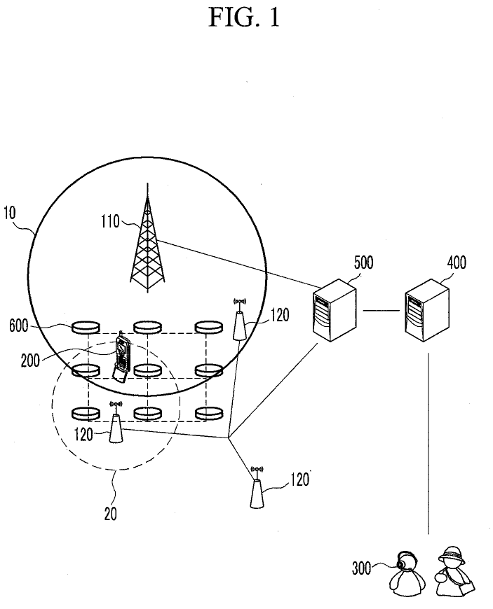

FIG. 1 shows a wireless communication system according to an exemplary embodiment of the present invention.

Referring to FIG. 1, the wireless communication system includes base stations 110 and 120, a terminal 200, a service requestor 300, a service platform 400, a positioning server 500, and a non-network-based positioning system 600.

The base stations 110 and 120 receive data from the terminal 200 or transmit the data to the terminal 200.

The base station 110 manages a first communication area 10, and the base station 120 manages a second communication area 20. A system in the first communication area 10 is different from a system in the second communication area 20, and the first communication area 10 is wider than the second communication area 20. For example, the first communication area 10 may support the code division multiple access (CDMA) system, the asynchronous wideband code division multiple access (WCDMA) system, the global system for mobile communication (GSM), and the public switched telephone network (PSTN), while the second communication area 20 can support the wireless local area network (WLAN) and the worldwide interoperability for microwave access (WiMax).

The terminal 200, an end point of a radio channel, accesses the base station 110 and transmits/receives data.

The terminal 200 represents a complex terminal for accessing the two base stations 110 and 120 supporting different communication systems. Power consumption by the terminal 200 when it is connected to the base station 110 is less than that when it is connected to the base station 120. Therefore, the terminal 200 is always connected to the base station 110, and it is selectively connected to the base station 120 in the case of collecting location information.

The service requestor 300 represents a subject for requiring location information of the terminal 200, that is, information including global coordinates, relative coordinates, and interior location of the terminal 200, and information including contents to be provided at the corresponding location, and it exists on the communication network or the web and is different from the terminal 200.

The service platform 400 transmits a request state to the positioning server 500 according to a location information request from the service requestor 300, and receives location information or measurement information for estimating location information from the positioning server 500.

Upon receiving the location information request from the service platform 400, the positioning server 500 transmits a message for notifying a session start to the terminal 200, and calculates location information by using the measurement information from the terminal 200 or receives location information.

The non-network-based positioning system 600 acquires the location of the terminal 200 without using the communication network, and for example, it can be a radio frequency identifier (RFID), a near field contact device, or an inertial navigation system.

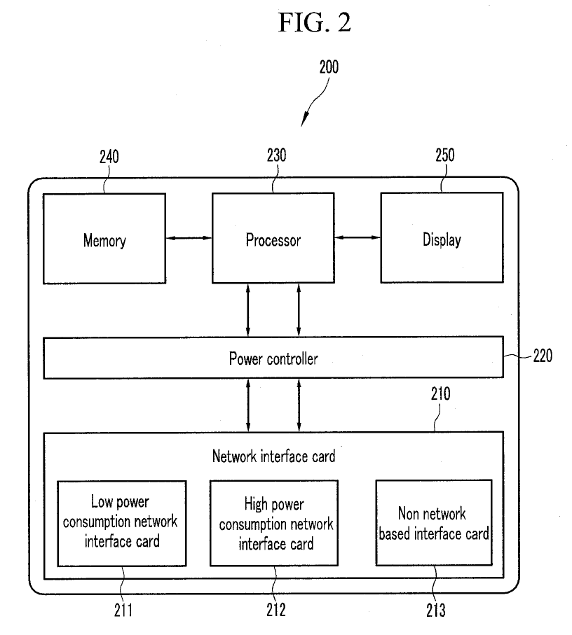

Referring to FIG. 2, a terminal according to an exemplary embodiment of the present invention will now be described.

FIG. 2 shows a block diagram of a terminal according to an exemplary embodiment of the present invention.

Referring to FIG. 2, the terminal 200 includes a network interface card 210, a power controller 220, a processor 230, a memory 240, and a display 250.

The network interface card 210 supports the terminal 200 to access the wireless communication network, and it includes a low power consumption network interface card 211, a high power consumption network interface card 212, and a non-network-based interface card 213.

The low power consumption network interface card 211 controls the terminal 200 to access the base station 110 of the first communication area 10. The low power consumption network interface card 211 is always turned on, and maintains performance of communication by the terminal 200 and receives a message for a location request service and responds to it.

The high power consumption network interface card 212 controls the terminal 200 to access the base station 120 of the second communication area 20.

The non-network-based interface card 213 controls the terminal 200 to access the non-network-based positioning system 600.

The high power consumption network interface card 212 and the non-network-based interface card 213 are turned off or stand by, and when the message for a location information request is provided, they are turned on or activated to collect measurement information on the location of the terminal 200 from the base station 120 and the non-network-based positioning system 600.

The power controller 220 controls the power states of the low power consumption network interface card 211, the high power consumption network interface card 212, and the non-network-based interface card 213 according to an instruction of the processor 230.

The processor 230 controls the power controller 220 to maintain the low power consumption network interface card 211 in the turned-on state, receives a message for the location request service to turn on or activate the high power consumption network interface card 212 and the non-network-based interface card 213, and turns off the high power consumption network interface card 212 and the non-network-based interface card 213 or controls them to be in the standby mode. Also, the processor 230 transmits measurement information required for location by the respective cards 211, 212, and 213 to the positioning server 500, or directly calculates the location by using the measurement information.

The memory 240 stores measurement information or location information on the location of the terminal 200, and the display 250 receives an input from a user of the terminal 200 or provides information to the user.

Accordingly, the terminal 200 includes a plurality of network interface cards 211, 212, and 213 having different functions, and the low power consumption network interface card 211, always turns on power to allow communication of the terminal 200 and turns on or activates the high power consumption network interface card 212 and the non-network-based interface card 213 to acquire location information when the location information is requested. Therefore, power consumption of the terminal 200 can be efficiently controlled, and when the location information is requested, further accurate location information can be acquired by using the network interface cards 211, 212, and 213.

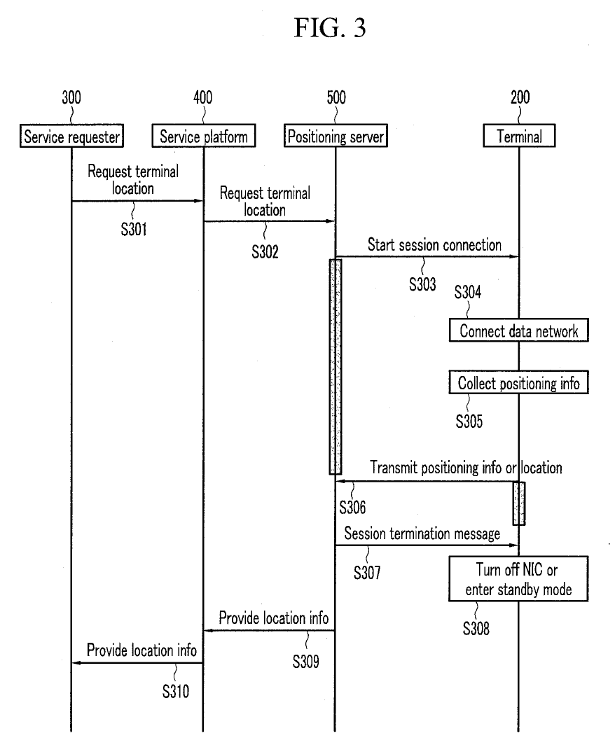

A method for providing a terminal's location according to an exemplary embodiment of the present invention will now be described with reference to FIG. 3.

FIG. 3 shows a flowchart of a method for a terminal to provide location information according to an exemplary embodiment of the present invention.

Referring to FIG. 3, a service requester 300 requests location information on the terminal 200 from the service platform 400 (S301).

Upon receiving the location information request, the service platform 400 transmits the location information request to the positioning server 500 (S302).

The positioning server 500 receives the location information request and transmits a message for starting session connection to the terminal 200 (S303).

While standing by while having turned on the low power consumption network interface card 211, the terminal 200 receives the message for starting session connection and connects to a data network (S304). The terminal 200 turns on or activates the high power consumption network interface card 212 and the non-network-based interface card 213 other than the low power consumption network interface card 211 and collects location measurement information (S305). The terminal 200 transmits the location measurement information collected from the base stations 110 and 120 and the non-network-based positioning system 600 to the positioning server 500, or transmits the location information calculated by the terminal 200 to the positioning server 500 (S306).

Upon receiving the location information or the location information, the positioning server 500 transmits a session termination message to the terminal 200 (S307).

Upon receiving the session termination message, the terminal 200 turns off the high power consumption network interface card 212 and the non-network-based interface card 213 rather than the low power consumption network interface card 211, or switches to the standby state (S308).

The positioning server 500 calculates location information of the terminal 200 based on measurement information to transmit it to the service platform 400 or transmit the location information provided by the terminal 200 to the service platform 400 (S309).

The service platform 400 provides the transmitted location information to the service requester 300.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A terminal for selectively accessing a plurality of base stations supporting different communication systems, comprising:
a first network interface card that is turned on when the terminal is turned on;
a second network interface card that is turned on or activated when receiving the terminal's location information request;
a power controller for controlling power of the first and second network interface cards; and
a processor for receiving the terminal's location information request and controlling the power of the first and second network interface cards through the power controller.

2. The terminal of claim 1, wherein
the first network interface card controls the terminal to access the first base station from among the plurality of base stations, and the second network interface card controls the terminal to access the second base station from among the plurality of base stations,
wherein power consumption of the terminal when accessing the first base station is less than that when accessing the second base station.

3. The terminal of claim 1, wherein
the first network interface card controls the terminal to access the first base station from among the plurality of base stations, and the second network interface card controls the terminal to access the second base station from among the plurality of base stations, and
wherein a communication area of the first base station is wider than a communication area of the second base station.

4. The terminal of claim 3, wherein
the processor collects the location information through the second base station while the second network interface card is turned on or activated.

5. The terminal of claim 4, wherein
the second network interface card is turned off or it enters a standby mode after the location information is collected.

6. The terminal of claim 4, further including a non-network-based interface card that is turned on or activated when receiving the terminal's location information request.

7. The terminal of claim 6, wherein
the processor collects the location information while the non-network-based interface card is turned on or activated.

8. The terminal of claim 7, wherein
the non-network-based interface card is turned off or enters the standby mode after the location information is collected.

9. A method for providing a location of a terminal selectively accessing a plurality of base stations supporting different communication systems, comprising:
controlling the terminal to access a first base station;
receiving the terminal's location information request from a service requester;
controlling the terminal to access a second base station while accessing the first base station when receiving the terminal's location information request;
controlling the terminal to collect the location information from the first and second base stations; and
providing the location information to the service requester.

10. The method of claim 9, wherein
the terminal's power consumption when accessing the first base station is greater than that when accessing the second base station.

11. The method of claim 10, further comprising
controlling the terminal to disconnect access to the second base station after providing the location information to the service requester.

12. The method of claim 11, further comprising
controlling the terminal to access a non-network-based positioning system while the terminal is connected to the first base station after receiving the terminal's location information request.

13. The method of claim 12, further comprising
controlling the terminal to collect the location information from the non-network-based positioning system.

14. The method of claim 13, further comprising
controlling the terminal to disconnect the access to the non-network-based positioning system after the providing of the location information to the service requester.

15. The method of claim 14, wherein
the terminal comprises a first network interface card for controlling the terminal to access the first base station, and
the controlling of the terminal to access the first base station comprises turning on the first network interface card.

16. The method of claim 14, wherein
the terminal comprises a second network interface card for controlling the terminal to access the second base station, and
the controlling of the terminal to access the second base station comprises turning on or activating the second network interface card.

17. The method of claim 14, wherein
the terminal comprises a non-network-based interface card for controlling the terminal to access the non-network-based positioning system, and
the controlling of the terminal to access the non-network-based positioning system comprises turning on or activating the non-network-based interface card.
